(19) United States
(12) Patent Application Publication
(10) Pub. No.: US 2012/0068459 A1
(43) Pub. Date: Mar. 22, 2012

(54) FITTING RING

(76) Inventor: Mao-Nan CHENG, Fongyuan City (TW)

(21) Appl. No.: 12/883,268

(22) Filed: Sep. 16, 2010

(51) Int. Cl. F16L 25/00

(52) U.S. Cl. 285/420

(57) ABSTRACT

A fitting ring for a dust collection bag of a dust collection machine includes a hard ring member. The hard ring member has a gap to form two ends. The ends of the hard ring member are provided with a fastening unit to tighten the gap. An open end of a dust collection bag is inserted in the hard ring member and then folded outwardly in a reversed direction. The user grasps the dust collection bag and the hard ring member to fit the dust collection bag on the outlet of a dust collection machine. Finally, the fastening unit is used to tighten the gap. The fitting ring of the present invention can couple the dust collection bag to the outlet of the dust collection machine simply and conveniently. The operation can be done by a single person to save the manpower and to enhance the efficiency.

### BACKGROUND OF THE INVENTION

1. Field of the Invention

The present invention relates to a fitting ring for a dust collection bag of a dust collection machine.

2. Description of the Prior Art

As shown in FIG. 1, a conventional dust collection machine 1 comprises an air collection box 1. The air collection box 1 has an outlet 2 and an annular limit flange 3 close to the outlet 2. To couple a dust collection bag 4 on the dust collection machine 1, the dust collection bag 4 is first fitted on the dust collection machine 1 and a fastener 5 is used to secure the dust collection bag 4 between the limit flange 3 near the outlet 2 and the air collection box 1, so the dust collection bag 4 is exactly coupled on the dust collection machine 1.

However, the fastener 5 is a strip which is thin, has lower hardness and is easy to deform. It is necessary for two persons to assemble the fastener 5. The dust collection bag 4 is fitted on the outlet 2 by one person, and the other person holds two ends of the fastener 5 with his/her both hands to coil the fastener 5 at the outlet 2 and then buckle a lock member 6 at the two ends of the fastener 5, such that the dust collection bag 4 is fastened on the dust collection machine 1. This assembly way needs more manpower, is not convenient, and takes a lot of time.

Accordingly, the inventor of the present invention has devoted himself based on his many years of practical experiences to solve this problem.

### SUMMARY OF THE INVENTION

The primary object of the present invention is to provide a fitting ring for a dust collection bag of a dust collation machine. The fitting ring can assist the user in replacing the dust collection bag with ease so as to enhance the work efficiency.

According to the present invention, there is provided a fitting ring for a dust collection bag of a dust collection machine. The fitting ring comprises a hard ring member and a fastening unit. The hard ring member is made of a material which has high hardness to keep the shape of the hard ring member. The hard ring member has a gap to form two ends. The hard ring member is slightly opened outward. The fastening unit includes an engaging seat and an engaging member. The engaging seat is disposed on one end of the hard ring member. The engaging member is disposed on the other end of the hard ring member to engage with the engaging seat for the gap of the hard ring member to be fastened tightly.

When a dust collection bag is coupled to an outlet of a dust collection machine, an open end of the dust collection bag is inserted in the hard ring member and then folded outwardly in a reversed direction. The user grasps the dust collection bag and the hard ring member to fit the dust collection bag on the outlet of the dust collection machine. The fitting ring of the present invention can couple the dust collection bag to the outlet of the dust collection machine simply and conveniently. The operation can be done by a single person to save the manpower and to enhance the efficiency.

### BRIEF DESCRIPTION OF THE DRAWINGS

FIG. 1 is a partially enlarged and exploded view of a conventional dust collection machine;

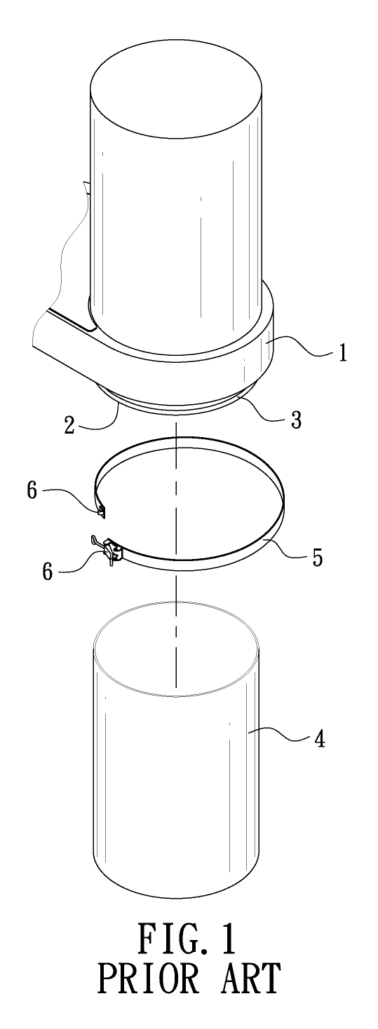

FIG. 2 is a perspective view according to a preferred embodiment of the present invention;

FIG. 3 is a cross-sectional view taken along line A-A according to the preferred embodiment of the present invention;

FIG. 4 is a schematic view to show that the dust collection bag is inserted in the hard ring member according to the preferred embodiment of the present invention;

FIG. 5 is a schematic view to show that the dust collection bag is inserted in the hard ring member and coupled to the dust collection machine according to the preferred embodiment of the present invention; and

FIG. 6 is a partially sectional view to show that the dust collection bag is inserted in the hard ring member and coupled to the dust collection machine according to the preferred embodiment of the present invention.

### DETAILED DESCRIPTION OF THE PREFERRED EMBODIMENTS

Embodiments of the present invention will now be described, by way of example only, with reference to the accompanying drawings.

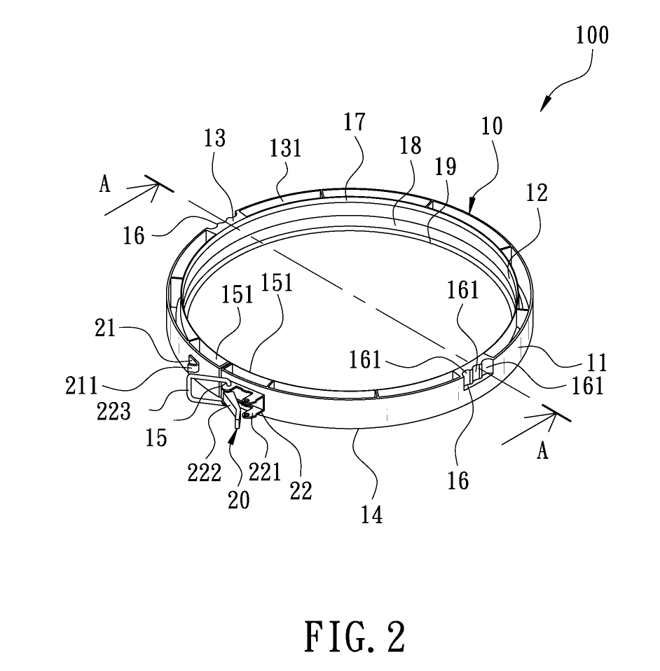

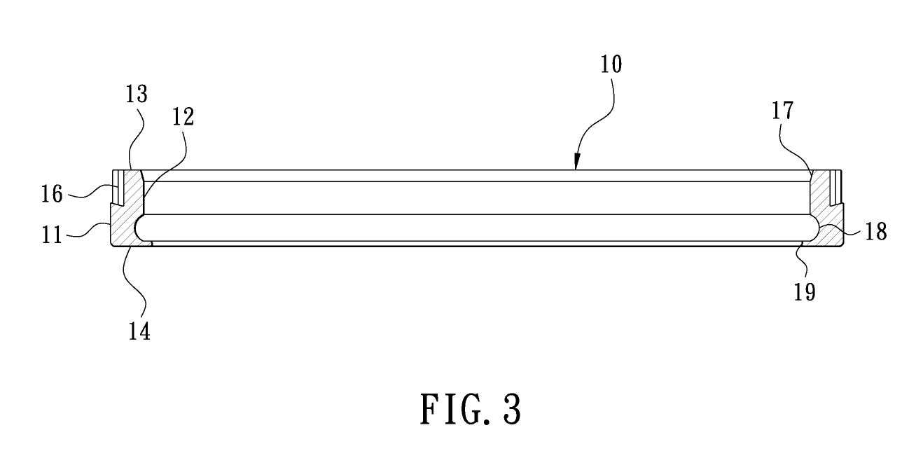

As shown in FIG. 2 and FIG. 3, a fitting ring 100 for a dust collection bag of a dust collection machine according to a preferred embodiment of the present invention comprises a hard ring member 10 and a fastening unit 20.

The hard ring member 10 is made of a material which has high hardness, such as polyvinyl chloride (PVC), so as to keep the shape of the hard ring member 10. The hard ring member 10 has an outer wall 11 and an inner wall 12. The hard ring member 10 has two opposing sides to define a top surface 13 and a bottom surface 14, respectively. The hard ring member 10 has a gap 15 to form two ends 151, so that the hard ring member 10 can be slightly opened outward. The outer wall 11 of the hard ring member 10 has at least two grasp portions 16 thereon. In this embodiment, each grasp portion 16 is composed of a plurality of curved recesses 161 which are disposed on the outer wall 11 of the hard ring member 10 and connected with each other for the user to grasp thereat. The inner wall 12 of the hard ring member 10 has an annular guide surface 17 close to the top surface 13. The inner wall 12 of the hard ring member 10 further has an annular groove 18 and an annular flange 19 close to the bottom surface 14. In addition, the hard ring member 10 has a plurality of troughs 131 from the top surface 13 to the bottom surface 14 so as to reduce the weight of the hard ring member 10.

The fastening unit 20 includes an engaging seat 21 and an engaging member 22. The engaging seat 21 is disposed on one end 151 of the hard ring member 10. The engaging member 22 is disposed on the other end 151 of the hard ring member 10 to engage with the engaging seat 21, so that the gap 15 of the hard ring member 10 is fastened tightly. In this embodiment, the engaging seat 21 has a hook 211. The engaging member 22 has a base 221, a pull handle 222 which is pivotally connected to the base 221, and a loop 223 which is pivotally connected to the pull handle 222. The loop 223 is adapted to engage with the hook 211. With the pull handle 222 to pull the hook 211, the engaging seat 21 and the engaging member 22 approach each other to tighten the gap 15 of the hard ring member 10.

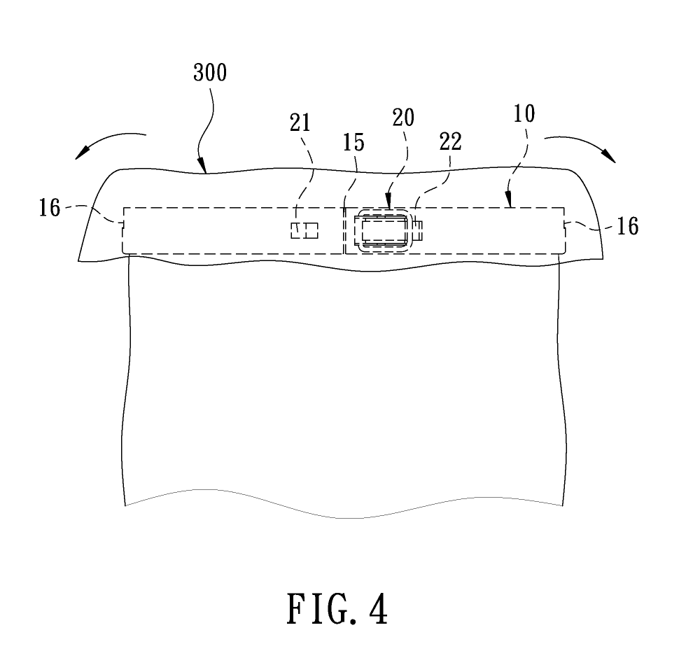

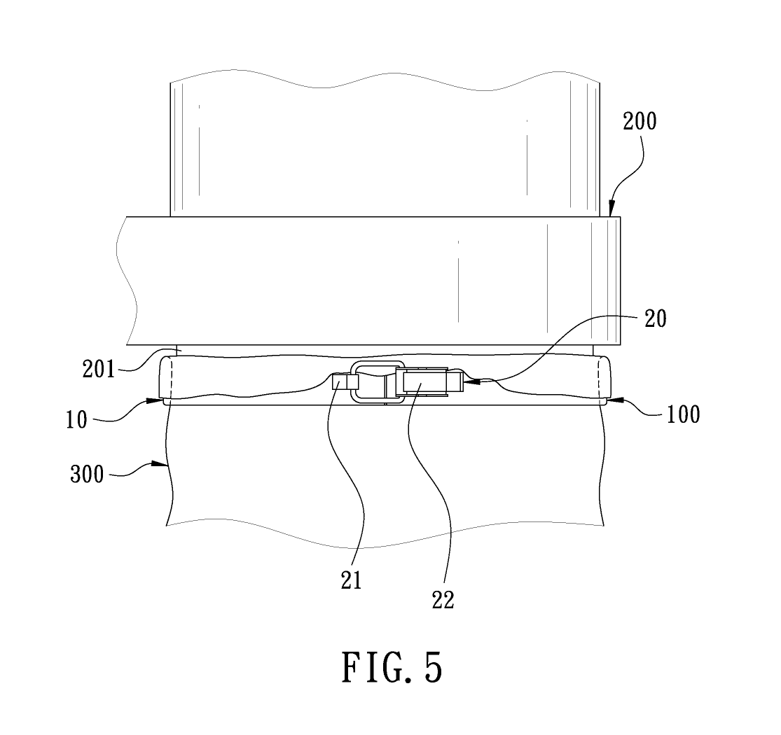

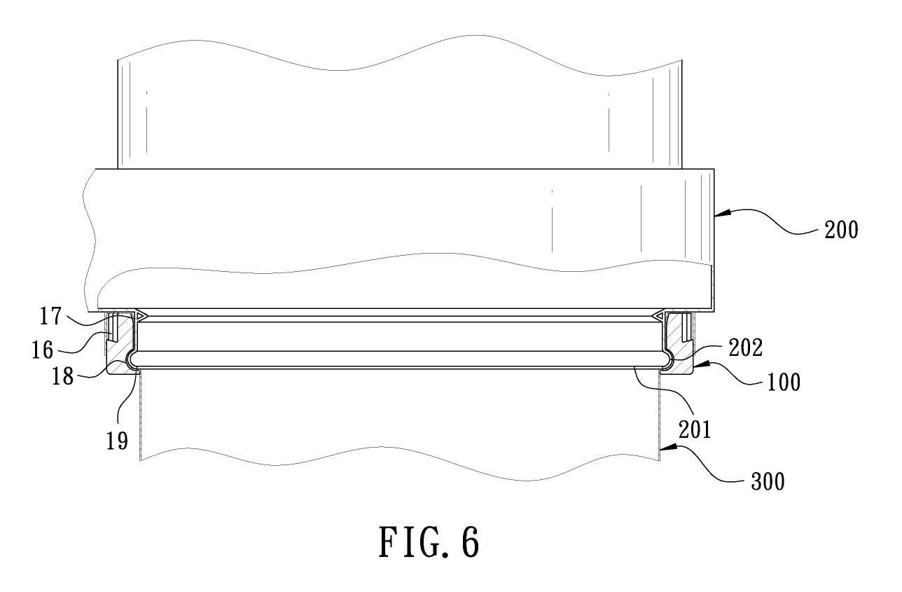

Referring to FIG. 4 to FIG. 6, when a dust collection bag 300 is coupled to an outlet 201 of a dust collection machine 200, an open end 301 of the dust collection bag 300 is inserted in the hard ring member 10 and then folded outwardly in a reversed direction. As shown in FIG. 4, the open end 301 of the dust collection bag 300 must be over the grasp portions 16. After that, the user grasps the dust collection bag 300 as well as the grasp portions 16 of the hard ring member 10 to fit the dust collection bag 300 on the outlet 201 of the dust collection machine 200. Because the hard ring member 10 has the gap 15, the hard ring member 10 is slightly open. Besides, the hard ring member 10 has the guide surface 17 close to the top surface 13, so the user can fit the hard ring member 10 on the outlet 201 of the dust collection machine 200 with ease. Furthermore, the hard ring member 10 has the annular groove 18, as shown in FIG. 6. When the hard ring member 10 is fitted on the outlet 201, the annular groove 18 will engage with a limit flange 202 which is disposed close to the outlet 201 to secure the hard ring member 10 on the outlet 201. Finally, the loop 223 of the engaging member 22 is engaged with the hook 211 of the engaging seat 21, and the pull handle 222 is pressed downward for the engaging seat 21 and the engaging member 22 to approach each other so as to tighten the gap 15 of the hard ring member 10. In this way, the dust collection bag 300 is secured to outlet 201 of the dust collection machine 200. It is noted that the hard ring member 10 has the annular flange 19, as shown in FIG. 6. When the dust collection bag 300 is secured to outlet 201, the annular flange 19 will hold against the limit flange 202 to press the dust collection bag 300 tightly, preventing the dust collection bag 300 from disengagement. The fitting ring 100 of the present invention can couple the dust collection bag 300 to the outlet 201 of the dust collection machine 200 simply and conveniently. The operation can be done by a single person to save the manpower and to enhance the efficiency.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A fitting ring for a dust collection bag of a dust collection machine, comprising:
a hard ring member made of a material which has high hardness to keep the shape of the hard ring member, the hard ring member having a gap to form two ends, the hard ring member being slightly opened outward; and
a fastening unit including an engaging seat and an engaging member, the engaging seat being disposed on one end of the hard ring member, the engaging member being disposed on the other end of the hard ring member to engage with the engaging seat for the gap of the hard ring member to be fastened tightly;
thereby, when a dust collection bag being coupled to an outlet of a dust collection machine, an open end of the dust collection bag being inserted in the hard ring member and folded outwardly in a reversed direction, the user grasping the dust collection bag and the hard ring member to fit the dust collection bag on the outlet of the dust collection machine.

2. The fitting ring as claimed in claim 1, wherein an outer wall of the hard ring member has at least two grasp portions thereon.

3. The fitting ring as claimed in claim 2, wherein each of the grasp portions is composed of a plurality of curved recesses which are disposed on the outer wall of the hard ring member and connected with each other.

4. The fitting ring as claimed in claim 1, wherein the hard ring member has two opposing sides to define a top surface and a bottom surface, respectively.

5. The fitting ring as claimed in claim 4, wherein an inner wall of the hard ring member has an annular guide surface close to the top surface.

6. The fitting ring as claimed in claim 4, wherein an inner wall of the hard ring member has an annular groove close to the bottom surface.

7. The fitting ring as claimed in claim 4, wherein an inner wall of the hard ring member has an annular flange close to the bottom surface.

8. The fitting ring as claimed in claim 4, wherein the hard ring member has a plurality of troughs from the top surface to the bottom surface.

9. The fitting ring as claimed in claim 1, wherein the engaging seat has a hook, the engaging member has a base, a pull handle which is pivotally connected to the base, and a loop which is pivotally connected to the pull handle, the loop is adapted to engage with the hook, with the pull handle to pull the hook, the engaging seat and the engaging member approach each other to tighten the gap of the hard ring member.

10. The fitting ring as claimed in claim 1, wherein the material of the hard ring member is polyvinyl chloride (PVC).
